(19) United States
(12) Patent Application Publication
(10) Pub. No.: US 2026/0219819 A1
(43) Pub. Date: Jul. 30, 2026

(54) IMAGE PROCESSING APPARATUS

(71) Applicant: CANON KABUSHIKI KAISHA, Tokyo (JP)

(72) Inventor: HIROYUKI SAKAI, Kanagawa (JP)

(21) Appl. No.: 19/460,098

(22) Filed: Jan. 26, 2026

(30) Foreign Application Priority Data
Jan. 27, 2025 (JP) 2025-011680

(51) Int. Cl. G06F 3/12

(52) U.S. Cl. CPC G06F 3/1243; G06F 3/1212

(57) ABSTRACT

An image processing apparatus performs whole rendering processing for performing rendering in whole with respect to first original data based on print setting data, replaces pre-replacement data included in second original data with first post-replacement data, performs partial rendering processing for performing rendering with respect to the first post-replacement data based on the print setting data, and performs image composition for combining image data obtained as a result of rendering performed by the whole rendering processing and image data obtained as a result of rendering performed by the partial rendering processing, wherein a region other than the pre-replacement data included in the second original data is identical to that included in the first original data.

### BACKGROUND

### Field of the Technology

The present disclosure relates to an image processing apparatus, an image processing system, a processing method for an image processing apparatus, and a storage medium.

### Description of the Related Art

In recent years, mobile or portable terminals such as smartphones and tablet-type personal computers (PCs) have become widespread. Therefore, in addition to conventional print processing operations which are performed in response to instructions from PCs, print processing operations which are performed in response to instructions from various types of terminals have to be assumed. Moreover, the functions of printers have also improved, and environments which enable printers to connect to various terminals via networks are being built. Moreover, there are many types of printers, and the number of types of printers is also increasing, including, in addition to conventional home printers, large-format printers, printers for professionals, and business printers for, for example, copying machines.

Moreover, software having, as one of the functions for print processing, a variable printing function which replaces a text portion of, for example, a poster with other text data or image data and then performs printing is also coming out. In the case of making replacement of variable data, which is to be replaced with other data, and then performing printing, if there are many contents which are to be replaced, text portions can be automatically replaced, so that the software can also be used for the case of performing printing in large quantities.

In poster data, in addition to text data, image data of, for example, Joint Photographic Experts Group (JPEG) or Portable Network Graphics (PNG), which has a large amount of data, may be arranged. Moreover, in poster data, for example, Scalable Vector Graphics (SVG) data which is fine in design may be arranged. SVG data which is fine in design may be larger in data size than compressed images of, for example, JPEG. To convert poster data into printing image data, it is necessary to perform rendering processing which reads in all of the above-mentioned pieces of data and converts the entirety of poster data into bitmaps (e.g., images). In performing rendering processing, for example, image data or SVG data arranged in poster data is read in and converted into an image. In this case, with respect to poster data including object data that is large in the amount of data, in performing rendering processing, it takes a large amount of time required to read in data. In performing variable printing, with respect to poster data, after replacement using variable replacement data is performed, rendering processing is performed. In a case where there are a plurality of pieces of variable replacement data, replacement processing using variable replacement data and rendering processing are repeated. In the case of poster data including object data large in the amount of data, since rendering processing is performed multiple times, it takes a lot of processing time.

Japanese Patent Laid-Open No. 2013-186743 describes a technique for a method which saves the trouble of performing rasterization processing of form data on each occasion of variable printing and thus enables high-speed image processing.

According to the technique described in Japanese Patent Laid-Open No. 2013-186743, it is possible to, before or after performing rasterization processing on image data, perform color conversion processing on the image data in conformity with a color profile. Moreover, the above-mentioned technique includes an image processing method which combines variable data and form data. Moreover, the above-mentioned technique includes a step (a) for determining which of variable data and form data image data included in a print job is.

Moreover, the above-mentioned technique includes a step (b) for, after performing color conversion processing, performing rasterization processing on the image data determined to be variable data in the step (a). Moreover, the above-mentioned technique includes a step (c) for determining whether the image data determined to be form data in the step (a) is form data already subjected to raster image processor (RIP) processing. Moreover, the above-mentioned technique includes a step (d) for, if it is determined that the image data is not form data already subjected to RIP processing in the step (c), performing RIP processing on the form data.

According to the technique described in Japanese Patent Laid-Open No. 2013-186743, it becomes possible to, before and after performing rendering, perform color conversion processing on the image data in conformity with a color profile. Controlling the color conversion processing enables saving the trouble of performing rasterization processing of form data on each occasion of variable printing and increasing the speed of image processing to be performed in variable printing.

However, in the technique described in Japanese Patent Laid-Open No. 2013-186743, increasing the speed of image processing is applicable only to the case of determining which of variable data and form data image data included in a print job is and performing color conversion processing on the image data depending on the result of determination. For example, it is not possible to increase the speed of image processing in the case of replacing a text portion included in poster data with variable data and then generating a plurality of pieces of poster data.

### SUMMARY

The present disclosure is directed to enabling efficiently performing rendering on original data obtained by replacing pre-replacement data with post-replacement data.

According to an aspect of the present disclosure, an image processing apparatus includes one or more processors; and one or more memories storing instructions that, when executed by the one or more processors, cause the information processing apparatus to: perform whole rendering processing for performing rendering in whole with respect to first original data based on print setting data; replace pre-replacement data included in second original data with first post-replacement data; perform partial rendering processing for performing rendering with respect to the first post-replacement data based on the print setting data; and perform image composition for combining image data obtained as a result of rendering performed by the whole rendering processing and image data obtained as a result of rendering performed by the partial rendering processing, wherein a region other than the pre-replacement data included in the second original data is identical to that included in the first original data.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of an image processing system according to a first embodiment.

FIG. 2 is a diagram illustrating a hardware configuration example of the image processing system.

FIG. 3 is a diagram illustrating a functional configuration example of a server computer.

FIG. 4 is a diagram illustrating a functional configuration example of a rendering processing unit in variable printing in the first embodiment.

FIG. 5 is a flowchart illustrating rendering processing in variable printing in the first embodiment.

FIG. 6 is a flowchart illustrating rendering processing in variable printing in a second embodiment.

FIGS. 7A, 7B, 7C, and 7D are diagrams illustrating pieces of poster data obtained before and after text replacement.

FIGS. 8A and 8B are diagrams each illustrating variable replacement data used for replacing text data.

FIGS. 9A and 9B are explanatory diagrams used to explain a whole rendering processing unit in the first embodiment.

FIGS. 10A, 10B, 10C, and 10D are explanatory diagrams used to explain a partial rendering processing unit in the first embodiment.

### DESCRIPTION OF THE EMBODIMENTS

Various embodiments, features, and aspects of the present disclosure will be described in detail below with reference to the drawings.

### First Embodiment

### Overall System Configuration

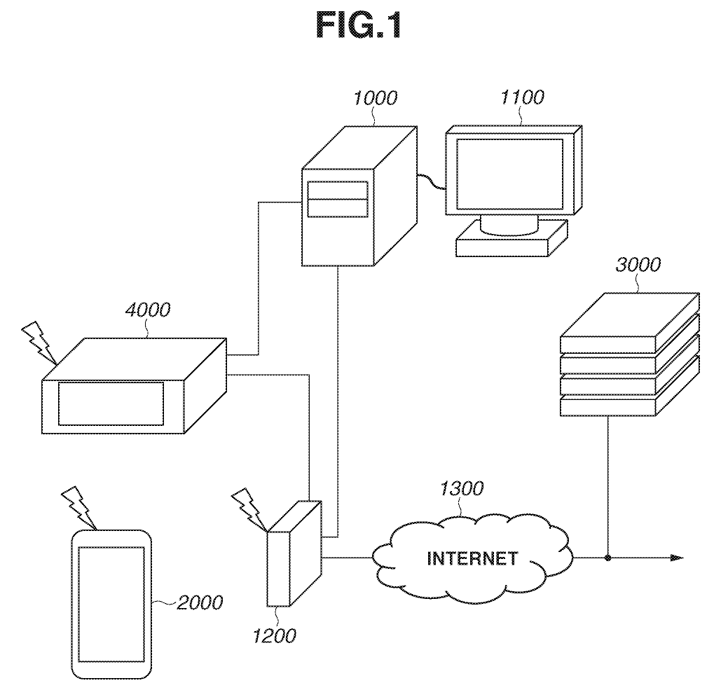

FIG. 1 is a diagram illustrating a configuration example of an image processing system according to a first embodiment. The image processing system includes a client computer 1000, a display 1100, a router 1200, a mobile terminal 2000, a server computer 3000, and a printer 4000.

The client computer 1000 is connected to the display 1100 by a communication cable, and displays data stored in the client computer 1000 on the display 1100.

Moreover, the client computer 1000 is connected to the router 1200 by wired communication or wireless communication, and is connected to, via the router 1200, other communication equipment capable of performing communication over the Internet 1300. The router 1200 is equipment which connects different networks with each other.

Moreover, the mobile terminal 2000 is connected to, by wireless communication via the router 1200, other communication equipment capable of performing communication over the Internet 1300.

Moreover, the server computer 3000 is connected to other communication equipment capable of performing communication over the Internet 1300. Then, the server computer 3000 receives data stored in the client computer 1000 or the mobile terminal 2000, stores the data in a memory, and performs processing of the data or transmission of the data to other equipment.

Moreover, the printer 4000 receives an image file stored in the client computer 1000, the mobile terminal 2000, or the server computer 3000 and performs printing of the image file on a print medium.

In the first embodiment, the image processing system is described with a connection configuration illustrated in FIG. 1 taken as an example.

### 1 Basic Configuration

### 1-1 Hardware Configuration

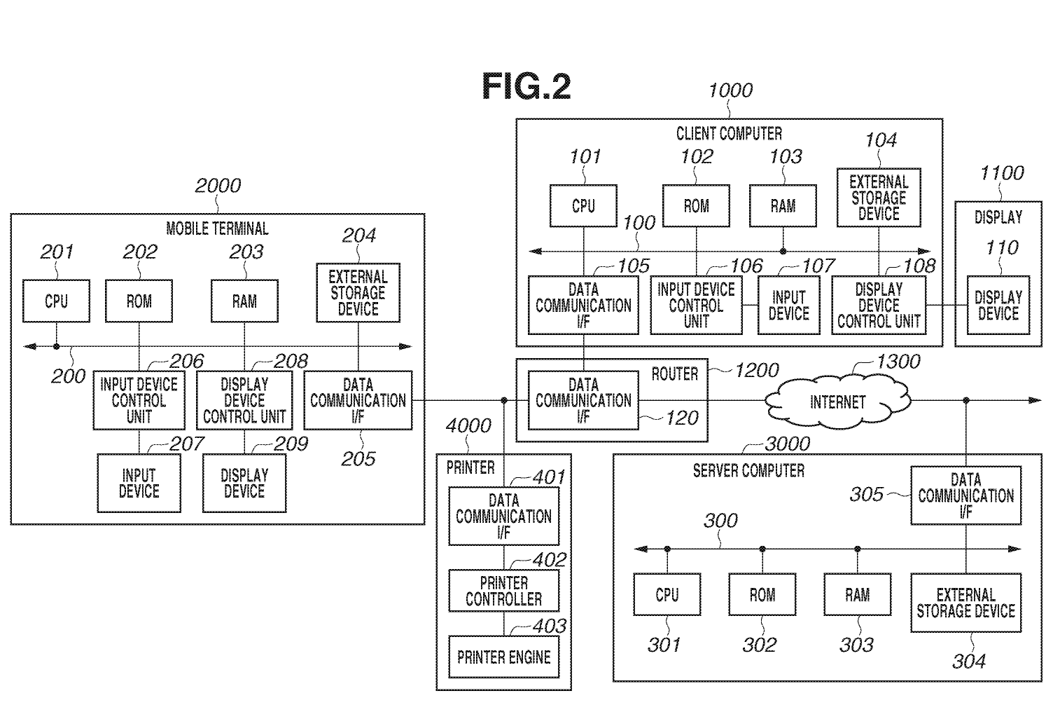

FIG. 2 is a diagram illustrating a hardware configuration example of the image processing system.

Referring to FIG. 2, the client computer 1000, the display 1100, the router 1200, the mobile terminal 2000, the server computer 3000, and the printer 4000, which have been described above with reference to FIG. 1, are described.

### Client Computer 1000

Referring to FIG. 2, the client computer 1000 is configured to include mainly the following elements. Each element of the client computer 1000 is connected to a bus 100.

A central processing unit (CPU) 101 is a central arithmetic device, and performs processing in conformity with a designated program.

A read-only memory (ROM) 102 is a non-volatile storage, and is capable of retaining table data and programs which are used for processing in the first embodiment described below.

A random access memory (RAM) 103 is a volatile storage, and temporarily retains programs and data.

An external storage device (e.g., external storage unit) 104 is a non-volatile storage, and retains programs and data.

The CPU 101 receives programs and image data stored in the ROM 102, the RAM 103, and the external storage device 104 and performs arithmetic processing.

A data communication interface (I/F) (e.g., data transfer interface) 105 controls transmission and reception of data between the server computer 3000 and the printer 4000 via the router 1200, which includes a data communication I/F 120. The connection method for such data transfer and reception to be used can be wired connection, such as Universal Serial Bus (USB), IEEE 1394, or a local area network (LAN), or wireless connection, such as Bluetooth or Wi-Fi.

An input device control unit 106 is an interface (I/F) which acquires information from an operation which the user has performed and transmits control information to each processing unit.

An input device 107 is a human interface device (HID) such as a keyboard and a mouse. The user is able to perform an input operation via the input device 107.

A display device control unit 108 transmits original data stored in the ROM 102, the RAM 103, or the external storage device 104 to the display 1100 and causes a display device 110 included in the display 1100 to display the received data.

In the following description, processing operations similar to the above-mentioned contents are omitted from description here.

### Mobile Terminal 2000

Referring to FIG. 2, the mobile terminal 2000 is configured to include mainly the following elements. Each element of the mobile terminal 2000 is connected to a bus 200.

The mobile terminal 2000 includes mainly the functions of a computer such as a tablet computer or a smartphone, and includes an input I/F capable of performing displaying on a display and capable of being operated with a touch panel.

A CPU 201 performs processing equivalent to that in the CPU 101.

A ROM 202 performs processing equivalent to that in the ROM 102.

A RAM 203 performs processing equivalent to that in the RAM 103.

An external storage device 204 is a device equivalent to the external storage device 104.

A data communication I/F 205 performs processing equivalent to that in the data communication I/F 105.

An input device control unit 206 performs processing equivalent to that in the input device control unit 106.

An input device 207 is a device equivalent to the input device 107 and is also a device which allows an input operation for performing an operation on a screen, such as a touch panel having the functions of displaying and inputting included in a tablet computer or a smartphone.

A display device control unit 208 is an I/F which transmits original data stored in the ROM 202, the RAM 203, or the external storage device 204 to a display device 209.

The display device 209 displays original data received from the display device control unit 208. The display device 209 is frequently incorporated in the mobile terminal 2000.

### Server Computer 3000

Referring to FIG. 2, the server computer 3000 is configured to include mainly the following elements. Each element of the server computer 3000 is connected to a bus 300.

A CPU 301 performs processing equivalent to that in the CPU 101.

A ROM 302 performs processing equivalent to that in the ROM 102.

A RAM 303 performs processing equivalent to that in the RAM 103.

An external storage device 304 is a device equivalent to the external storage device 104.

A data communication I/F 305 controls transmission and reception of data between the client computer 1000, the server computer 3000, and the printer 4000 via the router 1200.

The server computer 3000 is mainly connected to a network environment and has the function of performing transmission and reception of data with various types of terminals via the data communication I/F 305. Moreover, the server computer 3000 also has the function of performing processing for editing or modifying the received data.

### Printer 4000

Referring to FIG. 2, the printer 4000 is configured to include mainly the following elements.

A data communication I/F 401 controls transmission and reception of data between the client computer 1000, the mobile terminal 2000, and the server computer 3000 via the router 1200.

The printer 4000 receives print data which has been generated by any one of the client computer 1000, the mobile terminal 2000, and the server computer 3000. The print data includes mainly image data, which is used for printing, and print setting data, which is used for issuing a printing instruction.

A printer controller 402 performs control of a printer engine 403 in conformity with instruction data for the received print data.

Moreover, the printer controller 402 performs conversion of image data with use of, for example, color space conversion required for printing or color separation to color materials according to the type of a sheet, which is print setting data for the image data.

Moreover, the printer controller 402 performs image processing, such as output gradation correction or halftoning, with use of image processing parameters, such as a look-up table, to convert image data into recording data which is usable for printing.

Moreover, the printer engine 403 converts image data included in the received print data into respective pieces of ink color data and then performs print processing. Main processing included in the print processing includes controlling, over a print head, a heating action or pressure action of a heater mounted in the print head based on recording data and then discharging ink.

### 1-2 Functional Configuration

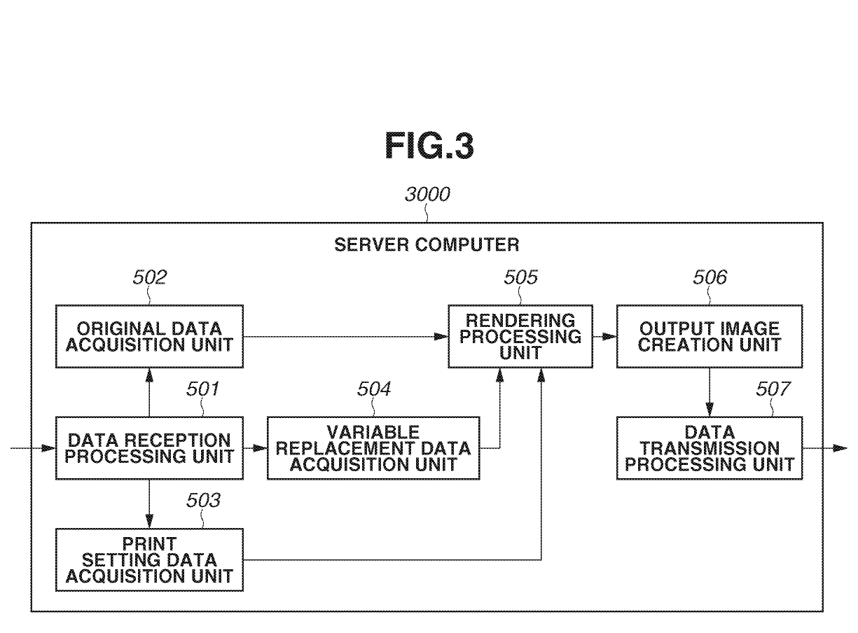

FIG. 3 is a diagram illustrating a functional configuration example of the server computer 3000, and each processing unit illustrated in FIG. 3 is described mainly about rendering processing for generating printing image data.

The CPU 301 implements each processing unit illustrated in FIG. 3 by executing programs.

Referring to FIG. 3, the server computer 3000 includes a data reception processing unit 501, an original data acquisition unit 502, a print setting data acquisition unit 503, a variable replacement data acquisition unit 504, a rendering processing unit 505, an output image creation unit 506, and a data transmission processing unit 507.

The data reception processing unit 501 is a processing unit which receives data concerning image data generation transmitted from the client computer 1000 or the mobile terminal 2000 via a communication I/F of each terminal. The data concerning image data generation includes mainly, for example, original data, print setting data, printer information about a transmission destination, and variable replacement data.

The original data acquisition unit 502 is a processing unit which acquires original data D1 included in the data received by the data reception processing unit 501. The original data acquisition unit 502 mainly acquires Hypertext Markup Language (HTML) or Cascading Style Sheets (CSS) data, which is able to be displayed by a browser. Alternatively, the original data acquisition unit 502 acquires what is called bitmap image data, which has been converted into an image-compressed file, for example, which has been converted by data compression, such as Joint Photographic Experts Group (JPEG), into an image file. Alternatively, the original data acquisition unit 502 acquires what is called vector image data such as a Scalable Vector Graphics (SVG) file. Alternatively, the original data acquisition unit 502 acquires font data which is to be applied to text data. Data which the original data acquisition unit 502 acquires can be any type of data as long as it is information which is able to be converted into printing image data by rendering processing described below.

The print setting data acquisition unit 503 is a processing unit which acquires print setting data D2 included in the data received by the data reception processing unit 501. The print setting data D2 includes mainly, for example, model information about a printer, a paper supply method, paper size, paper type, print quality, borderless printing designation information, duplex printing, binding direction, and paper orientation, which are related to creation of printing image data. Alternatively, the print setting data D2 includes output image size information calculated from various print settings.

The variable replacement data acquisition unit 504 acquires variable replacement data D3 which is to be used for replacing text or an image before being converted into printing image data, which has been received by the data reception processing unit 501. For example, the variable replacement data D3 is text information in the case of being used for replacing text and is image information in the case of being used for replacing an image. The variable replacement data D3 can be any data as long as data obtained by replacement is data able to be converted into printing image data by the rendering processing unit 505 described below. For example, the variable replacement data D3 in the case of being data to be used for replacing text can be data in which text information formed by spreadsheet software is included. Moreover, the variable replacement data D3 in the case of being data to be used for replacing image information can be data such as a uniform resource locator (URL) in which image information is stored.

The rendering processing unit 505 is a processing unit which performs rendering on original data subjected to replacement using variable replacement data, at an image size calculated by print setting data. The rendering processing unit 505 transmits, to the output image creation unit 506, data converted into an image by rendering processing, as printing image data D4 or printing post-image composition data D7. The details of the rendering processing unit 505 are described below.

The output image creation unit 506 is a processing unit which converts data converted into an image generated by the rendering processing unit 505, i.e., the printing image data D4 or the printing post-image composition data D7, into an image file. For example, the output image creation unit 506 converts the printing image data D4 or the printing post-image composition data D7 into an image file with a compression format such as JPEG or Portable Network Graphics (PNG). The method of conversion into an image file is implemented by a known technique.

The data transmission processing unit 507 performs data communication of an image file generated by the output image creation unit 506 to another terminal via a communication I/F. The printer 4000 is an example of an image forming apparatus, which receives an image file from the data transmission processing unit 507 and then prints the received image file.

In the first embodiment, the client computer 1000 includes software which performs processing for transmitting, to a printer driver or a printer, print data subjected to replacement using variable replacement data and then subjected to rendering. The present software for performing processing for shortening a processing time required for rendering processing in variable printing, which is one of features of the first embodiment, is described below.

### 2 Characteristic Configuration

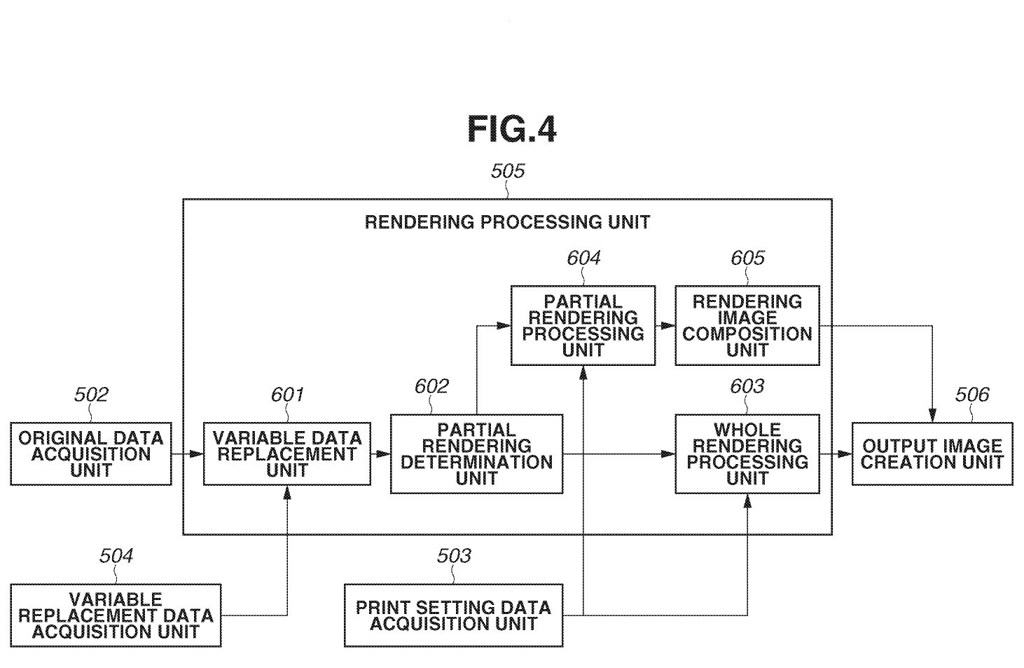

In the first embodiment, a characteristic configuration is added to software which runs on the client computer 1000. The characteristic configuration is described with reference to FIG. 4.

FIG. 4 is an explanatory diagram of a functional configuration example of the rendering processing unit 505 in variable printing in the first embodiment.

Referring to FIG. 4, the rendering processing unit 505 includes a variable data replacement unit 601, a partial rendering determination unit 602, a whole rendering processing unit 603, a partial rendering processing unit 604, and a rendering image composition unit 605. Each processing unit of the rendering processing unit 505 is repeatedly used a number of times corresponding to the number of pieces of data to be subjected to replacement.

The variable data replacement unit 601 is a processing unit which creates an original post-replacement data E1 obtained by making replacement using the variable replacement data D3 with respect to the original data D1.

First, the variable data replacement unit 601 acquires the original data D1 from the original data acquisition unit 502. For example, the original data D1 is assumed to be poster creating data composed of HTML or CSS data and a PNG image. The poster creating data is data in which text information or image information is written in the content of HTML data.

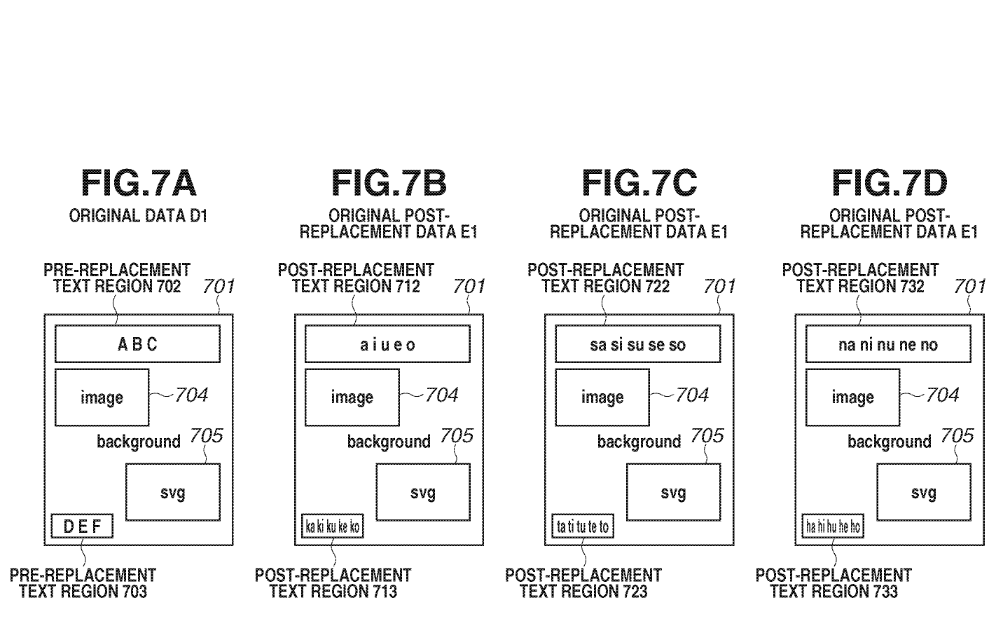

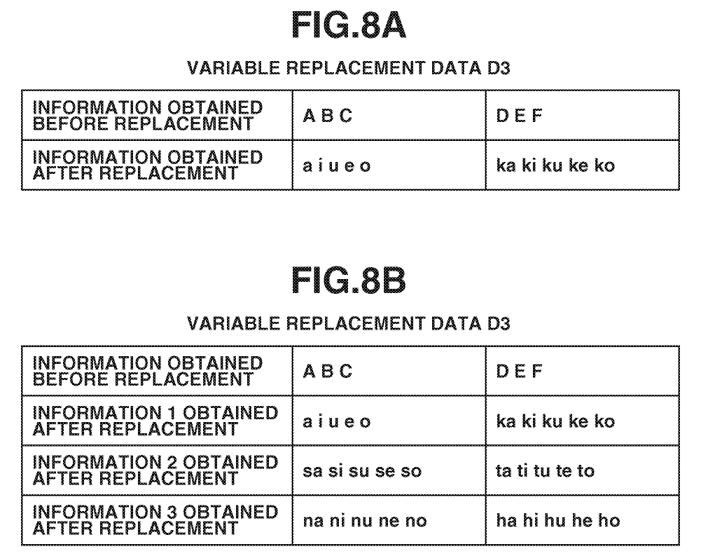

Next, the variable data replacement unit 601 acquires the variable replacement data D3 from the variable replacement data acquisition unit 504. The variable replacement data D3 is assumed to be data to be used for replacing text information or image information described in HTML data with respect to the original data D1. The variable replacement data D3 is described with reference to FIGS. 7A, 7B, 7C, and 7D and FIGS. 8A and 8B.

FIGS. 7A to 7D are diagrams illustrating images of pieces of poster data obtained before and after replacement of text.

FIG. 7A is a diagram illustrating an image of poster data obtained before text replacement. For example, it is assumed that, as poster creating data, as illustrated in FIG. 7A, "A B C" and "D E F" are written in text data of HTML of the original data D1. Referring to FIG. 7A, in the background of poster data 701, a pre-replacement text region 702, a pre-replacement text region 703, an image region 704, and an SVG region 705 are arranged. The pre-replacement text region 702 has "A B C" input therein, and the pre-replacement text region 703 has "D E F" input therein. The pre-replacement text regions 702 and 703 are assumed to be targets for variable replacement data.

FIGS. 8A and 8B each illustrate variable replacement data which is to be used for replacing text data.

FIG. 8A illustrates variable replacement data D3 which is to be used for replacing two pieces of text data with respect to the poster data obtained before text replacement illustrated in FIG. 7A.

Referring to FIG. 8A, the variable replacement data D3 is assumed to be used for replacing text data "A B C" with text data "a i u e o" and replacing text data "D E F" with text data "ka ki ku ke ko", i.e., information in which information obtained before replacement and information obtained after replacement are written.

For example, the following pieces of information are written in the variable replacement data D3 illustrated in FIG. 8A:

Information obtained before replacement "A B C" and "D E F"; and

Information obtained after replacement "a i u e o" and "ka ki ku ke ko".

Information obtained before replacement "A B C", which is the variable replacement data D3 illustrated in FIG. 8A, is equivalent to text data written in the pre-replacement text region 702 illustrated in FIG. 7A. Moreover, information obtained before replacement "D E F", which is the variable replacement data D3 illustrated in FIG. 8A, is equivalent to text data written in the pre-replacement text region 703 illustrated in FIG. 7A.

FIG. 7B is a diagram illustrating an image of poster data E1 obtained after text replacement.

Information obtained after replacement "a i u e o", which is the variable replacement data D3 illustrated in FIG. 8A, is equivalent to text data written in a post-replacement text region 712 illustrated in FIG. 7B. Moreover, information obtained after replacement "ka ki ku ke ko", which is the variable replacement data D3 illustrated in FIG. 8A, is equivalent to text data written in a post-replacement text region 713 illustrated in FIG. 7B.

The variable data replacement unit 601 extracts, from the poster data 701 illustrated in FIG. 7A, text data coincident with the information obtained before replacement "A B C", which is the variable replacement data D3 illustrated in FIG. 8A. The variable data replacement unit 601 replaces the extracted information obtained before replacement "A B C", which is the variable replacement data D3 illustrated in FIG. 8A, with information obtained after replacement "a i u e o" of text data coincident with "A B C".

Moreover, the variable data replacement unit 601 extracts, from the poster data 701 illustrated in FIG. 7A, text data coincident with the information obtained before replacement "D E F", which is the variable replacement data D3 illustrated in FIG. 8A. The variable data replacement unit 601 replaces the extracted information obtained before replacement "D E F", which is the variable replacement data D3 illustrated in FIG. 8A, with information obtained after replacement "ka ki ku ke ko" of text data coincident with "D E F".

In short, the variable data replacement unit 601 performs processing for replacing text data with use of the variable replacement data D3 illustrated in FIG. 8A with respect to the poster data illustrated in FIG. 7A and thus generating poster data illustrated in FIG. 7B.

Moreover, in a case where there is a plurality of pieces of information with which to make replacement, the variable replacement data D3 becomes information in which information obtained before replacement and a plurality of pieces of information obtained after replacement are written.

The variable replacement data D3 illustrated in FIG. 8B is variable replacement data which is to be used for replacing each of two pieces of text data with any one of three pieces of text data.

For example, the following pieces of information are written in the variable replacement data D3 illustrated in FIG. 8B:

Information obtained before replacement "A B C" and "D E F";

Information 1 obtained after replacement "a i u e o" and "ka ki ku ke ko";

Information 2 obtained after replacement "sa si su se so" and "ta ti tu te to"; and

Information 3 obtained after replacement "na ni nu ne no" and "ha hi hu he ho".

Information obtained before replacement "A B C", which is the variable replacement data D3 illustrated in FIG. 8B, is equivalent to text data written in the pre-replacement text region 702 illustrated in FIG. 7A. Moreover, information obtained before replacement "D E F", which is the variable replacement data D3 illustrated in FIG. 8B, is equivalent to text data written in the pre-replacement text region 703 illustrated in FIG. 7A.

FIG. 7B is a diagram illustrating an image of poster data E1 obtained after text replacement.

Information 1 obtained after replacement "a i u e o", which is the variable replacement data D3 illustrated in FIG. 8B, is equivalent to text data written in the post-replacement text region 712 illustrated in FIG. 7B. Moreover, information 1 obtained after replacement "ka ki ku ke ko", which is the variable replacement data D3 illustrated in FIG. 8B, is equivalent to text data written in the post-replacement text region 713 illustrated in FIG. 7B.

The variable data replacement unit 601 extracts, from the poster data 701 illustrated in FIG. 7A, text data coincident with the information obtained before replacement "A B C", which is the variable replacement data D3 illustrated in FIG. 8B. The variable data replacement unit 601 replaces the extracted information obtained before replacement "A B C", which is the variable replacement data D3 illustrated in FIG. 8B, with information 1 obtained after replacement "a i u e o" of text data coincident with "A B C".

Moreover, the variable data replacement unit 601 extracts, from the poster data 701 illustrated in FIG. 7A, text data coincident with the information obtained before replacement "D E F", which is the variable replacement data D3 illustrated in FIG. 8B. The variable data replacement unit 601 replaces the extracted information obtained before replacement "D E F", which is the variable replacement data D3 illustrated in FIG. 8B, with information 1 obtained after replacement "ka ki ku ke ko" of text data coincident with "D E F".

FIG. 7C is a diagram illustrating an image of poster data E1 obtained after text replacement.

Information 2 obtained after replacement "sa si su se so", which is the variable replacement data D3 illustrated in FIG. 8B, is equivalent to text data written in a post-replacement text region 722 illustrated in FIG. 7C. Moreover, information 2 obtained after replacement "ta ti tu te to", which is the variable replacement data D3 illustrated in FIG. 8B, is equivalent to text data written in a post-replacement text region 723 illustrated in FIG. 7C.

The variable data replacement unit 601 extracts, from the poster data 701 illustrated in FIG. 7A, text data coincident with the information obtained before replacement "A B C", which is the variable replacement data D3 illustrated in FIG. 8B. The variable data replacement unit 601 replaces the extracted information obtained before replacement "A B C", which is the variable replacement data D3 illustrated in FIG. 8B, with information 2 obtained after replacement "sa si su se so" of text data coincident with "A B C".

Moreover, the variable data replacement unit 601 extracts, from the poster data 701 illustrated in FIG. 7A, text data coincident with the information obtained before replacement "D E F", which is the variable replacement data D3 illustrated in FIG. 8B. The variable data replacement unit 601 replaces the extracted information obtained before replacement "D E F", which is the variable replacement data D3 illustrated in FIG. 8B, with information 2 obtained after replacement "ta ti tu te to" of text data coincident with "D E F".

FIG. 7D is a diagram illustrating an image of poster data E1 obtained after text replacement.

Information 3 obtained after replacement "na ni nu ne no", which is the variable replacement data D3 illustrated in FIG. 8B, is equivalent to text data written in a post-replacement text region 732 illustrated in FIG. 7D. Moreover, information 3 obtained after replacement "ha hi hu he ho", which is the variable replacement data D3 illustrated in FIG. 8B, is equivalent to text data written in a post-replacement text region 733 illustrated in FIG. 7D.

The variable data replacement unit 601 extracts, from the poster data 701 illustrated in FIG. 7A, text data coincident with the information obtained before replacement "A B C", which is the variable replacement data D3 illustrated in FIG. 8B. The variable data replacement unit 601 replaces the extracted information obtained before replacement "A B C", which is the variable replacement data D3 illustrated in FIG. 8B, with information 3 obtained after replacement "na ni nu ne no" of text data coincident with "A B C".

Moreover, the variable data replacement unit 601 extracts, from the poster data 701 illustrated in FIG. 7A, text data coincident with the information obtained before replacement "D E F", which is the variable replacement data D3 illustrated in FIG. 8B. The variable data replacement unit 601 replaces the extracted information obtained before replacement "D E F", which is the variable replacement data D3 illustrated in FIG. 8B, with information 3 obtained after replacement "ha hi hu he ho" of text data coincident with "D E F".

In short, the variable data replacement unit 601 performs processing for replacing text data with use of the variable replacement data D3 illustrated in FIG. 8B with respect to the poster data illustrated in FIG. 7A and thus generating pieces of poster data illustrated in FIGS. 7B, 7C, and 7D.

In the following description, information obtained before replacement is referred to as "field information". Moreover, information obtained after replacement is referred to as "record information". In the case of the above-mentioned variable replacement data D3 illustrated in FIG. 8B, "A B C" and "D E F" correspond to two fields and the pieces of information 1 to 3 obtained after replacement correspond to three records. The variable data replacement unit 601 uses such variable replacement data D3 to make replacement of the original data D1.

Next, the variable data replacement unit 601 extracts, from the acquired original data D1, information obtained before replacement based on the variable replacement data D3.

For example, in the case of replacing text information, the variable data replacement unit 601 extracts a tag including text from types of tags of HTML of the original data D1. The method of extracting a tag including text from HTML information includes various methods and can be any method as long as it is a known method capable of extracting text information such as the position of a text portion and the content thereof. The variable data replacement unit 601 compares the extracted text information of HTML with field information of the variable replacement data D3 and extracts coincident text information.

Next, the variable data replacement unit 601 replaces information obtained before replacement of the original data D1 coincident with field information of the variable replacement data D3 with record information of the variable replacement data D3.

For example, pieces of text information obtained before replacement are assumed to be "A B C" and "D E F", and pieces of text information of the coincident information 1 obtained after replacement are assumed to be "a i u e o" and "ka ki ku ke ko". The variable data replacement unit 601 replaces the position of text information "A B C" of the original data D1 with record information "a i u e o" of the variable replacement data D3. Moreover, the variable data replacement unit 601 replaces the position of text information "D E F" of the original data D1 with record information "ka ki ku ke ko" of the variable replacement data D3. Then, the variable data replacement unit 601 sets the information obtained as a result of replacement as original post-replacement data E1 and transmits the original post-replacement data E1 to the partial rendering determination unit 602. Moreover, the variable data replacement unit 601 sets information about the position and content coincident with field information of the variable replacement data D3 as extraction result information E3 and transmits the extraction result information E3 to the partial rendering determination unit 602.

The partial rendering determination unit 602 is a processing unit which performs determination as to whether to perform rendering in whole with respect to the original post-replacement data E1 or whether to perform rendering in part with respect to a replaced portion.

First, the partial rendering determination unit 602 acquires the original post-replacement data E1 from the variable data replacement unit 601. Moreover, the partial rendering determination unit 602 acquires the extraction result information E3, which is coincident with field information of the variable replacement data D3. The partial rendering determination unit 602 uses the received extraction result information E3 for the determination as to whether to perform rendering in part described below. The extraction result information E3 is, for example, the type of an object targeted for replacement obtained by performing data extraction from the original data D1 and position information about the object.

For example, referring to FIG. 7A, the pre-replacement text region 702 and the pre-replacement text region 703, which are coincident with field information of the variable replacement data D3, serve as main targets.

The extraction result information E3 includes, first, size information about the entire poster. Moreover, the extraction result information E3 includes position information, with respect to the size information about the entire poster, of the pre-replacement text region 702 and the pre-replacement text region 703 serving as replacement targets. The extraction result information E3 also includes background information of the poster data 701 overlapping the pre-replacement text region 702 and the pre-replacement text region 703 and positional relationship information about overlapping with another object. The method of acquiring position information about each object included in the extraction result information E3 can be any method as long as it is a known technique capable of acquiring position information about an object to be extracted mainly from the value of HTML or CSS. Each of HTML and CSS retains information available for numerically calculating position information for the entire poster, such as the width of the entire poster, the size in height, and the arrangement coordinates, arrangement proportion, and arrangement size of each object. The partial rendering determination unit 602 is able to calculate the extraction result information E3 by using the function of calculating the coordinate position of each object from HTML elements with use of, for example, a known JavaScript library.

Next, in a case where rendering has never been performed with respect to the original post-replacement data E1, the partial rendering determination unit 602 determines to perform rendering in whole.

Moreover, with regard to rendering for the second and subsequent times, in a case where performing rendering in part is favorable, the partial rendering determination unit 602 determines to perform rendering in part and, in the other cases, the partial rendering determination unit 602 determines to perform rendering in whole.

For example, the case where performing rendering in part is favorable is a case where a processing time obtained by adding a processing time required for performing rendering in part and a time required for combining the data subjected to rendering in part and an image subjected to rendering in whole is shorter than a processing time required for performing rendering in whole. In a case where, in the original post-replacement data E1, a plurality of images large in size is arranged at portions other than the portions at which data has been replaced, performing rendering in part enables shortening a processing time. In the case of performing rendering in whole, it becomes necessary to also perform rendering with respect to data at portions other than the portions subjected to replacement. In this case, if a plurality of images large in size is arranged, a long processing time is required because, for example, a time required for read-in of a corresponding plurality of pieces of image data and a time required for changing sizes of images to sizes adapted for arrangement are taken. Moreover, in the case of performing rendering in part, suppose a case where the replaced data is text and no image is arranged at the portion subjected to replacement. In this case, since the read-in of an image becomes unnecessary and rendering only needs to be performed with use of only a text region subjected to replacement and a background portion, a processing time can be significantly shortened. Then, if image data subjected to rendering at the first time is preliminarily retained on a memory, image data in a region subjected to rendering in part only needs to be combined therewith, so that a total processing time becomes shorter than that required for performing rendering processing in whole.

Moreover, for example, an SVG file is also similar to a large image size. In a case where an SVG file is arranged with a combination of more complicated pieces of information in the original data D1, it is supposed that a long rendering processing time is required. In a case where the replaced data is text and a complicated SVG file is not arranged in a region in which rendering is performed in part, processing for performing rendering in part becomes shorter in processing time than processing for performing rendering in whole. In this way, the partial rendering determination unit 602 can perform determination from the point of view that performing rendering in part enables making a processing time shorter than performing rendering in whole.

For example, a method of specifically determining whether a processing time becomes shorter includes preliminarily recording a whole rendering processing time for the first record of replacement data and comparing the preliminarily recorded processing time with a partial rendering processing time for the first record of replacement data. If the partial rendering processing time is the shorter one, the method is able to determine to perform partial rendering processing for the second and subsequent records.

Moreover, for example, in the case of performing whole rendering processing for the first record of replacement data, the method can predict a processing time for the second record. The method preliminarily calculates a total data size of pieces of image data arranged in the original data D1 at the time of performing whole rendering processing for the first record. Moreover, the method determines whether a portion to be subjected to replacement is not overlapping the arranged images. In the case of performing rendering in part, if a large image overlaps a portion to be subjected to rendering, it is supposed that a reading-in time for the image becomes long, so that the method can use such information about overlapping as a basis for determining whether to perform partial rendering processing.

Moreover, for example, the method can calculate an image size obtained by performing rendering in whole and an image size obtained by performing rendering in part and use the results of calculation as a basis for determining whether to perform partial rendering processing. For the case of performing rendering in part, data for the image size obtained by performing rendering in whole and data for the image size obtained by performing rendering in part become preliminarily required for image composition processing. In the case of performing rendering in part, a time required for such image composition becomes additional as compared with the case of performing rendering in whole at one time. Since processing for image composition is copy processing which is performed on a pixel-by-pixel basis, a read-in time and a write-in time for partial region images become required. The method can preliminarily predict a time required for performing rendering processing in whole, a time required for performing rendering processing in part, and a time required for image composition based on the processing ability of the CPU 301 and perform determination as to whether performing rendering in part is able to make a processing time shorter than performing rendering in whole.

In this way, any method can be used as long as it is a method which is capable of comparing a time required for whole rendering processing and a time required for partial rendering processing and image composition with each other.

Then, in a case where it is determined that performing rendering in part is required, the partial rendering determination unit 602 transitions to the partial rendering processing unit 604 and transmits the original post-replacement data E1 and the extraction result information E3 coincident with field information of the variable replacement data D3 thereto. In the other cases, the partial rendering determination unit 602 determines that performing rendering in whole is required, thus transitions to the whole rendering processing unit 603, and transmits the original post-replacement data E1 thereto.

The whole rendering processing unit 603 is a processing unit which performs rendering in whole with respect to the original post-replacement data E1 based on the acquired print setting data D2.

First, the whole rendering processing unit 603 acquires the original post-replacement data E1 subjected to replacement by the variable data replacement unit 601 from the partial rendering determination unit 602.

Next, the whole rendering processing unit 603 acquires the print setting data D2 acquired by the print setting data acquisition unit 503.

Next, the whole rendering processing unit 603 calculates a printing area image size P1 from the original post-replacement data E1 and the print setting data D2. For example, with regard to the print setting data D2, the sizes of width and height of a printable area P2 in a case where bordered printing with a paper size of A4 (a resolution of 300 dots per inch (dpi)) has been set are assumed to be 4,500 pixels and 6,800 pixels, respectively. With regard to the original post-replacement data E1, the sizes of width and height in a case where a paper size of A4 has been set as the original size of HTML are assumed to be 21 centimeters (cm) and 29.7 cm, respectively. As the sizes of width and height of the printable area P2, sizes determined by a combination with the setting content can be preliminarily retained, or sizes acquired from the printer 4000 can be used. The whole rendering processing unit 603 performs calculation of sizes subjected to enlargement processing and reduction processing in such a manner that the original post-replacement data E1 fits into the printable area P2. The whole rendering processing unit 603 calculates sizes which fit into the sizes of width and height of the printable area P2 while remaining the ratio of width and height (e.g., aspect ratio) of the original post-replacement data E1 unchanged. Since 4500 / 21 × 29.7 is approximately equal to 6364, the sizes of width and height of the printing area image size P1 become 4,500 pixels and 6,364 pixels, respectively. While, in the first embodiment, sizes are determined in such a manner that the original post-replacement data E1 fits into the printable area P2, the first embodiment is not limited to this. Any method can be used as long as it is enlargement and reduction processing capable of eventually performing conversion into image data for printing with sizes calculated by the setting of the print setting data D2.

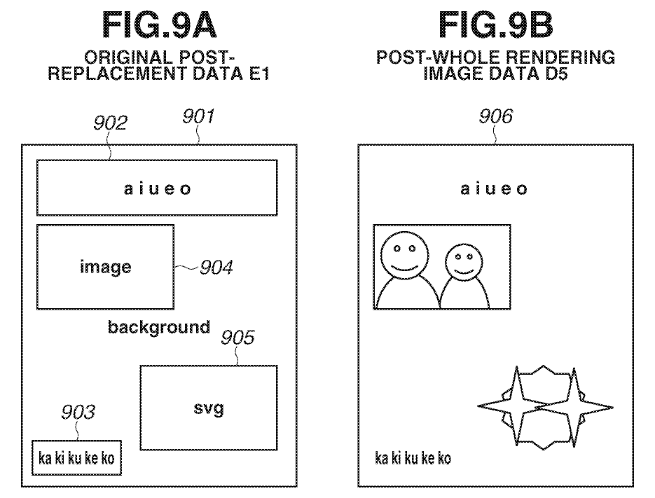

Next, the whole rendering processing unit 603 performs rendering of the original post-replacement data E1, which has been replaced with use of variable replacement data, in conformity with the calculated printing area image size P1. The rendering processing is mainly processing for converting, into a bitmap (e.g., into an image), the state of original data D1 of HTML or CSS being displayed on a browser. Any known method for rendering processing can be used as long as it is a method of converting original data D1 of HTML or CSS into an image. For example, the whole rendering processing unit 603 can use a virtual browser and, although not performing displaying to the user, draw the original post-replacement data E1 in conformity with the calculated printing area image size P1. Then, the whole rendering processing unit 603 can screen-capture the data drawn on the virtual browser and convert the data into image data of red-green-blue (RGB) values. Such processing is described with reference to FIGS. 9A and 9B.

FIGS. 9A and 9B are explanatory diagrams of the whole rendering processing unit 603.

FIG. 9A is a diagram illustrating an image of poster data obtained after text replacement.

Referring to FIG. 9A, in a poster data background 901, a text region 902, a text region 903, an image region 904, and an SVG region 905 are arranged. The text regions 902 and 903 are assumed to be targets for variable replacement data and are assumed to be in the state of having been already subjected to replacement by variable replacement data.

FIG. 9B illustrates post-whole rendering image data D5 obtained by performing whole rendering of the poster data obtained after text replacement illustrated in FIG. 9A.

Referring to FIG. 9B, the post-whole rendering image data D5 is data which has been rendered in such a way as to fit into the calculated printing area image size P1. For example, with regard to the background 901 illustrated in FIG. 9A, a background color is set in the range of fitting into the printing area image size P1. Moreover, only text portions in the text region 902 and the text region 903 subjected to replacement are arranged. Moreover, an image file designated in the image region 904 is read in, is subjected to enlargement or reduction in such a way as to be fitted to the image region 904, and is then arranged. SVG data designated in the SVG region 905 is read in and is then arranged in such a way as to be fitted to the SVG region 905. Then, the whole data is targeted for rendering, and a result of rendering being performed is set as the post-whole rendering image data D5.

Next, the whole rendering processing unit 603 sets the post-whole rendering image data D5, which has been converted into an image by rendering processing, as printing image data D4 and then transmits the printing image data D4 to the output image creation unit 506.

Next, the whole rendering processing unit 603 stores the post-whole rendering image data D5, which has been obtained by performing rendering in whole, in a memory. For example, the whole rendering processing unit 603 stores, in the memory, a result of rendering performed in whole to be used for variable printing for the first record for which rendering has never been performed. The whole rendering processing unit 603 stores such a result of rendering as data for image composition with image data rendered in part for the second and subsequent records. In the case of storing the rendering result in a memory, the whole rendering processing unit 603 can temporarily store the rendering result in a memory such as the RAM 103 and then use the stored rendering result for image composition to be performed after partial rendering. Moreover, the whole rendering processing unit 603 can store, in the external storage device 104, the rendering result in a state in which image deterioration does not occur even if the rendering result is converted into a compressed file such as PNG, in such a way as to allow the rendering result to be used for subsequent rendering processing. In this way, any method can be used as long as it enables image data obtained by performing rendering in whole to be used for subsequent rendering processing.

The partial rendering processing unit 604 is a processing unit which performs rendering in part with respect to the original post-replacement data E1 based on the extraction result information E3, which is coincident with field information of the acquired variable replacement data D3, and the print setting data D2.

First, the partial rendering processing unit 604 acquires, from the partial rendering determination unit 602, the original post-replacement data E1 subjected to replacement by the variable data replacement unit 601 and the extraction result information E3.

Next, the partial rendering processing unit 604 acquires the print setting data D2 acquired by the print setting data acquisition unit 503.

Next, the partial rendering processing unit 604 calculates the printing area image size P1 from the original post-replacement data E1 and the print setting data D2. The method of calculating the printing area image size P1 is similar to that used by the whole rendering processing unit 603 and is, therefore, omitted from description here.

Next, the partial rendering processing unit 604 performs rendering processing in part with respect to the original post-replacement data E1 based on the calculated printing area image size P1 and the acquired extraction result information E3.

For example, the partial rendering processing unit 604 excludes information not related to replacement processing from the position and content extracted from within HTML data serving as the original post-replacement data E1 based on the extraction result information E3, and then displays the data obtained by excluding the information not related to replacement processing on a virtual browser.

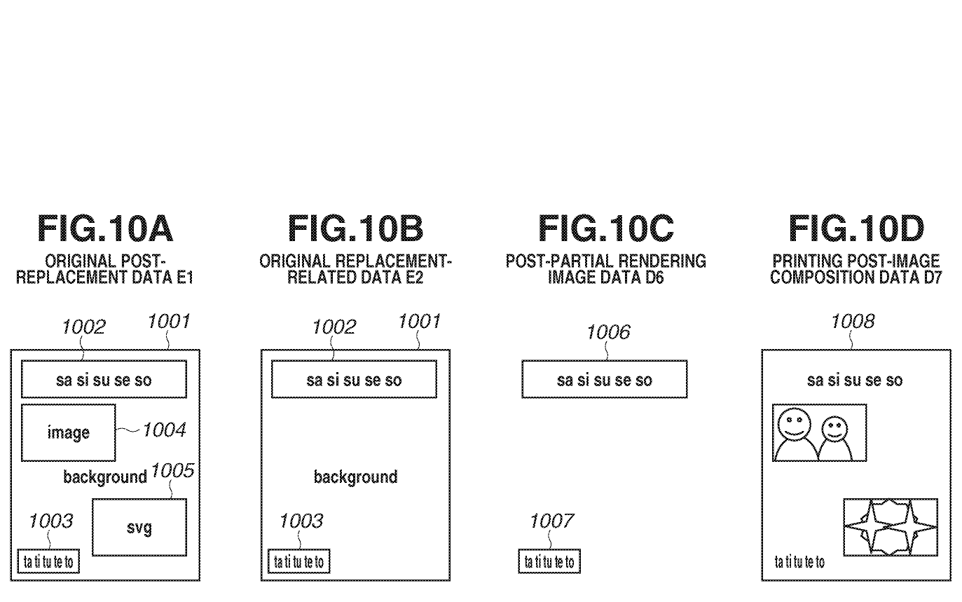

The information not related to replacement processing refers to an image, an SVG file, or another object within each piece of HTML data which does not overlap a region to be subjected to replacement processing. Moreover, when displaying the data obtained by excluding the information not related to replacement processing on the virtual browser, the partial rendering processing unit 604 performs displaying at the calculated printing area image size P1. Then, with regard to a region for which to perform rendering processing in part, the partial rendering processing unit 604 screen-captures only a region acquired based on the extraction result information E3 related to replacement which is being displayed on the virtual browser, and then converts the screen-captured region into image data of RGB values. Partial rendering processing is described with reference to FIGS. 10A, 10B, 10C, and 10D.

FIGS. 10A to 10D are explanatory diagrams of the partial rendering processing unit 604.

FIG. 10A is a diagram illustrating an image of poster data obtained after text replacement.

Referring to FIG. 10A, in a poster data background 1001, a text region 1002, a text region 1003, an image region 1004, and an SVG area 1005 are arranged. The text regions 1002 and 1003 are assumed to be targets for variable replacement data and are assumed to be in the state of having been already subjected to replacement by variable replacement data.

FIG. 10B is a diagram illustrating an image of poster data obtained by excluding information not related to replacement processing therefrom. The image region 1004 and the SVG region 1005 correspond to the information not related to replacement processing and, therefore, the partial rendering processing unit 604 deletes the image region 1004 and the SVG region 1005 from poster data. Only original replacement-related data E2, which is related to replacement processing, becomes poster data targeted for partial rendering.

FIG. 10C is a diagram illustrating an image of post-partial rendering image data, which is obtained by performing partial rendering. The partial rendering processing unit 604 performs partial rendering with respect to the original replacement-related data E2 illustrated in FIG. 10B, and thus obtains post-partial rendering image data 1006 and post-partial rendering image data 1007 as post-partial rendering image data D6.

Next, the partial rendering processing unit 604 sets data converted into an image by performing rendering processing in part as the post-partial rendering image data D6 and transmits the post-partial rendering image data D6 to the rendering image composition unit 605. Moreover, the partial rendering processing unit 604 transmits, to the rendering image composition unit 605, coordinate data E4, which indicates a region converted into an image by performing rendering processing in part with respect to the calculated printing area image size P1.

The rendering image composition unit 605 is a processing unit which performs image composition for combining image data which has preliminarily been rendered in whole with image data which has been rendered in part.

First, the rendering image composition unit 605 acquires the post-partial rendering image data D6, which has been obtained by performing rendering processing in part, from the partial rendering processing unit 604. Moreover, the rendering image composition unit 605 acquires the coordinate data E4, which indicates a region converted into an image by performing rendering processing in part, with respect to the calculated printing area image size P1.

Next, the rendering image composition unit 605 acquires the post-whole rendering image data D5, which has been stored by the whole rendering processing unit 603.

Next, the rendering image composition unit 605 performs image composition to combine the acquired post-whole rendering image data D5 with the post-partial rendering image data D6 based on the coordinate data E4, and thus generates the printing post-image composition data D7. Such processing is described with reference to FIGS. 9A and 9B and FIGS. 10A to 10D.

For example, the rendering image composition unit 605 temporarily stores, in the RAM 103, the post-whole rendering image data D5, which has been obtained by whole rendering with record 1 of the replacement data. FIG. 9B illustrates the post-whole rendering image data D5 as an example. Then, the rendering image composition unit 605 performs image composition by replacing the post-partial rendering image data D6 acquired from the partial rendering processing unit 604 on the position of the coordinate data E4 of the post-whole rendering image data D5 temporarily stored in the RAM 103. FIG. 10C illustrates post-partial rendering image data 1006 and post-partial rendering image data 1007 as an example.

The rendering image composition unit 605 performs image composition to combine the post-whole rendering image data D5 illustrated in FIG. 9B with the post-partial rendering image data 1006 and the post-partial rendering image data 1007 illustrated in FIG. 10C. The rendering image composition unit 605 sets image data 1008 obtained by image composition as printing post-image composition data D7 illustrated in FIG. 10D.

Next, the rendering image composition unit 605 transmits, as the printing image data D4, the printing post-image composition data D7 obtained by image composition to the output image creation unit 506.

### 2-1 Flowchart in First Embodiment

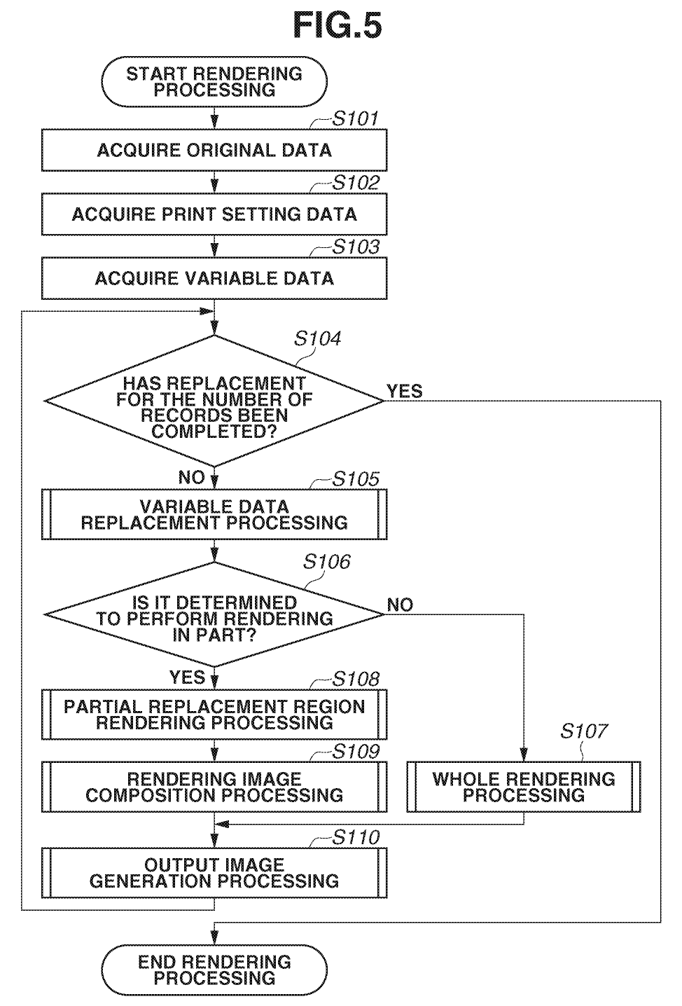

FIG. 5 is a flowchart used to explain rendering processing in variable printing, which is characteristic in the first embodiment. In the following description, a processing method which the server computer 3000 performs is described. The server computer 3000 is an example of an image processing apparatus.

First, in step S101, the above-mentioned original data acquisition unit 502 illustrated in FIG. 4 performs processing for acquiring original data D1.

Specifically, in step S101, the original data D1 is information representing input image data to be used for printing and an input data size thereof, which is displayed by a browser or a dedicated application. The input image data represents, for example, photographic image data which has been obtained by an image capturing apparatus performing image capturing. Moreover, the input image data represents, for example, image data which has been edited by image editing software. Moreover, the input image data is, for example, HTML or CSS data which is able to be displayed by a browser or vector data such as SVG data. Moreover, the input image data can be any type of data as long as it is information which is able to be converted into image data by the rendering processing unit 505. The input data size can be any data as long as it is data indicating the size of data to be input, such as height and width sizes or aspect ratio data.

Next, in step S102, the above-mentioned print setting data acquisition unit 503 illustrated in FIG. 4 performs print setting data acquisition processing for acquiring, as print setting data D2, model information about a printer and print setting information which are used for performing printing.

Specifically, in step S102, the print setting data acquisition unit 503 acquires, from within a printer driver installed on the client computer 1000, print setting data D2 about a printer which is designated by the user or is preliminarily set by default. The acquired print setting data D2 contains mainly print settings of the printer which have been set. The print setting data includes, for example, model information about the printer, paper supply information about the printer, paper size, the type of paper, printing quality, bordered or borderless setting, and duplex print setting. For example, the printable area size varies depending on the type of the printer. Moreover, with regard to the paper supply information, the printable area size varies depending on paper which has been set in the printer, such as cut sheet or roll paper. Moreover, the printable area size varies depending on the paper size. Moreover, with regard to the type of paper, the printable area size varies depending on high-quality paper or low-grade paper such as plain paper. Moreover, with regard to the printing quality, the printable area size varies depending on the setting of high image quality or low image quality. With regard to the bordered or borderless setting, the printable area size varies depending on bordered printing or borderless printing.

Next, in step S103, the above-mentioned variable replacement data acquisition unit 504 illustrated in FIG. 4 performs variable data acquisition processing for acquiring variable replacement data D3 to perform variable printing.

Specifically, in step S103, the variable replacement data acquisition unit 504 acquires variable replacement data D3 which has been stored in the client computer 1000, the mobile terminal 2000, or the server computer 3000. The acquired variable replacement data D3 contains mainly information obtained before replacement and information obtained after replacement. The information obtained before replacement represents original data obtained before making replacement of text information or image information written in HTML or CSS data with respect to the original data D1. The information obtained after replacement represents one piece or a plurality of pieces of data obtained after making replacement of text information or image information written in HTML or CSS data with respect to the original data D1. For example, the variable replacement data acquisition unit 504 acquires the variable replacement data D3 as one file in which information obtained before replacement and data obtained after replacement have been written.

For example, a configuration in which, if the variable replacement data acquisition unit 504 is configured to be able to acquire information formed by spread sheet software, information obtained before replacement and data obtained after replacement are included in a file formed by spread sheet software can be employed. Moreover, a configuration in which, if the variable replacement data acquisition unit 504 is configured to be able to acquire information in a comma-separated values (CSV) format, information obtained before replacement and data obtained after replacement are included in a CSV file can be employed. Moreover, with regard to text information, a configuration in which, if the variable replacement data acquisition unit 504 is configured to be able to acquire information in a preliminarily determined format, information obtained before replacement and data obtained after replacement are included in a text file can be employed. In this way, any method can be used as long as it is a method capable of acquiring information obtained before replacement and information obtained after replacement. Moreover, if information obtained before replacement and information obtained after replacement are associated with each other, information obtained before replacement and information obtained after replacement can be contained in the same file or can be formed as respective different files.

Next, in step S104, the rendering processing unit 505, while performing replacement processing a number of times corresponding to the number of records of information obtained after replacement of the variable replacement data D3 acquired in step S103, determines whether replacement processing for the number of times corresponding to the number of records has been completed.

If, in step S104, it is determined that replacement processing for the number of times corresponding to the number of records of information obtained after replacement of the variable replacement data D3 has been completed (YES in step S104), the rendering processing unit 505 determines that rendering processing has ended. If it is determined that replacement processing for the number of times corresponding to the number of records of information obtained after replacement of the variable replacement data D3 has not been completed (NO in step S104), the rendering processing unit 505 advances the processing to variable data replacement processing step S105 described below.

Next, in step S105, the above-mentioned variable data replacement unit 601 illustrated in FIG. 4 performs processing for replacement using the variable replacement data D3 with respect to the original data D1.

Specifically, in step S105, the variable data replacement unit 601 performs the above-described processing.

The variable data replacement unit 601 replaces pre-replacement data in the original data D1 with post-replacement data therein and thus generates original post-replacement data E1. For example, the variable data replacement unit 601 generates original post-replacement data E1 illustrated in FIG. 7B in loop processing in the first time, generates original post-replacement data E1 illustrated in FIG. 7C in loop processing in the second time, and generates original post-replacement data E1 illustrated in FIG. 7D in loop processing in the third time. The pieces of original post-replacement data E1 illustrated in FIGS. 7B to 7D differ in post-replacement data from each other as illustrated in FIG. 8B and are the same as each other in regions other than the pre-replacement data and post-replacement data.

Pre-replacement data and post-replacement data illustrated in FIG. 8B are text data. Moreover, regions other than pre-replacement data included in the original data D1 illustrated in FIG. 7A include image data, SVG data, or font data.

Next, in step S106, the above-mentioned partial rendering determination unit 602 illustrated in FIG. 4 determines whether to perform rendering in whole with respect to the original post-replacement data E1 or perform rendering in part with respect to replaced portions.

The above-mentioned determination is an example of determination as to whether a predetermined condition is satisfied. For example, in loop processing in the first time, the partial rendering determination unit 602 determines to perform rendering in whole and, in loop processing in the second and subsequent times, the partial rendering determination unit 602 determines to perform rendering in part. If the predetermined condition is satisfied, the partial rendering determination unit 602 determines to perform rendering in part, and, if the predetermined condition is not satisfied, the partial rendering determination unit 602 determines to perform rendering in whole.

For example, the predetermined condition is the condition that a first processing time is shorter than a second processing time.

The first processing time is a total time which is the sum of a processing time in a case where the partial rendering processing unit 604 performs rendering with respect to post-replacement data based on the print setting data D2 and a processing time in a case where the rendering image composition unit 605 performs image composition to combine image data obtained as a result of rendering performed by the whole rendering processing unit 603 with respect to the original data D1 and image data obtained as a result of rendering performed by the partial rendering processing unit 604.

The second processing time is a processing time in a case where the whole rendering processing unit 603 performs rendering in whole with respect to original data in which pre-replacement data has been replaced with post-replacement data by the variable data replacement unit 601.

Moreover, the predetermined condition can be the condition that predetermined data is included in a region other than pre-replacement data included in the original data D1. For example, the predetermined data is image data with a size greater than or equal to a first threshold value, SVG data with a size greater than or equal to a second threshold value, or font data with a size greater than or equal to a third threshold value.

In step S106, the partial rendering determination unit 602 performs the above-described processing. If it is determined to perform rendering in whole (NO in step S106), the partial rendering determination unit 602 advances the processing to whole rendering processing step S107 described below. Moreover, if it is determined to perform rendering in part (YES in step S106), the partial rendering determination unit 602 advances the processing to partial rendering processing step S108 described below.

Next, in step S107, the above-mentioned whole rendering processing unit 603 illustrated in FIG. 4 performs rendering in whole with respect to the original post-replacement data E1 based on the acquired print setting data D2.

Specifically, in step S107, the whole rendering processing unit 603 performs the above-described processing. The whole rendering processing unit 603 stores, in a memory, the printing image data D4, which has been converted into an image by the whole rendering processing. Moreover, the whole rendering processing unit 603 transmits the printing image data D4, which has been converted into an image by the whole rendering processing, to the output image creation unit 506 and then advances the processing to output image generation processing step S110 described below.

Next, in step S108, the above-mentioned partial rendering processing unit 604 illustrated in FIG. 4 performs rendering in part with respect to the original post-replacement data E1 based on the extraction result information E3 coincident with field information of the acquired variable replacement data D3 and the print setting data D2.

Specifically, in step S108, the partial rendering processing unit 604 performs the above-described processing. After performing the partial rendering processing, the partial rendering processing unit 604 advances the processing to rendering image composition processing step S109 described below.

Next, in step S109, the above-mentioned rendering image composition unit 605 illustrated in FIG. 4 performs processing for performing image composition to combine image data obtained as a result of preliminarily performing rendering in whole in step S107 with image data obtained as a result of performing rendering in part in step S108.

Specifically, in step S109, the rendering image composition unit 605 performs the above-described processing. The rendering image composition unit 605 transmits the printing post-image composition data D7, which has been converted into an image by the rendering image composition processing, to the output image creation unit 506, and then advances the processing to output image generation processing step S110 described below.

Next, in step S110, the above-mentioned output image creation unit 506 illustrated in FIG. 4 performs processing for creating an image file of the printing image data D4 or the printing post-image composition data D7, which has been generated and converted into an image by the rendering processing unit 505.

After, in step S110, converting each image obtained by rendering into an image file, the output image creation unit 506 returns the processing to step S104 for determining whether replacement for the number of times corresponding to the number of records has been completed. As mentioned above, in a case where there is a plurality of pieces of record information as replacement information, the server computer 3000 repeats step S104 to step S110, thus repeating replacement processing and rendering processing. Moreover, data converted into an image file is transmitted to the data transmission processing unit 507 and is then transmitted to the subsequent printer driver or printer to be used for printing.

### 2-2 Effect of First Embodiment

In the first embodiment, in the case of performing conversion into an image while changing a content to be rendered based on replacement data and then performing print processing as in variable printing, it becomes possible to significantly shorten a processing time required for rendering processing, depending on a condition for replacement.

For example, suppose a case where the size of an object arranged at a portion other than a portion targeted for replacement of original data to be rendered is large. If, in a case where rendering has been performed in whole after replacement with variable data, an object large in size is included, reading-in of object data is time-consuming. Moreover, since conversion into an image is performed while rendering is performed in whole and, therefore, a region size to be subjected to conversion into an image is large, a large amount of time is required. Compared to this, rendering is performed only on information related to a region in which variable data has been replaced. Performing rendering on a limited region avoids the necessity of reading in object data unrelated to a replacement region and thus enables significantly shortening a processing time. Moreover, since conversion into an image is performed while rendering is performed in part, processing is shortened as compared with conversion into an image is performed while rendering is performed in whole. However, since data for printing is unable to be created from only an image subjected to rendering on only a partial region, composition processing is performed to combine the image and an image once subjected to rendering in whole. In the case of printing the same original data for each of a plurality of records as in variable printing, retaining data obtained by once performing rendering in whole enables performing rendering in part for the remaining number of records and then performing image composition, so that it becomes easier to obtain a beneficial effect. In this way, including the function of performing rendering in part in variable printing enables shortening a processing time.

### Second Embodiment

In the above-described first embodiment, in a case where rendering has never been performed with respect to the original post-replacement data E1, the partial rendering determination unit 602 determines to perform rendering in whole. In short, the first embodiment is an embodiment which, after performing the first replacement of data targeted for replacement, once performs whole rendering and then performs rendering in part with respect to subsequent data targeted for replacement. A second embodiment, which performs rendering in part from the beginning of data targeted for replacement, is described.

Processing operations in the second embodiment similar to those in the above-described first embodiment are omitted from description here.

### 3-1 Functional Configuration of Second Embodiment

As with the first embodiment, FIG. 3 is an explanatory diagram of a functional configuration example of an image processing apparatus in the second embodiment. FIG. 3 illustrates a functional configuration example of the server computer 3000, and each processing unit illustrated in FIG. 3 is described with regard to, mainly, rendering processing for generating printing image data.

Referring to FIG. 3, the server computer 3000 includes the data reception processing unit 501, the original data acquisition unit 502, the print setting data acquisition unit 503, the variable replacement data acquisition unit 504, the rendering processing unit 505, the output image creation unit 506, and the data transmission processing unit 507.

Processing operations in the second embodiment similar to those in the above-described first embodiment are omitted from description here.

The whole rendering processing unit 603 is a processing unit which performs rendering in whole with respect to original data D1 obtained before original replacement based on the acquired print setting data D2.

First, the whole rendering processing unit 603 acquires original data D1 from the original data acquisition unit 502.

Next, the whole rendering processing unit 603 acquires print setting data D2 which has been acquired by the print setting data acquisition unit 503.

Next, the whole rendering processing unit 603 calculates a printing area image size P1 from the original data D1 and the print setting data D2.

Next, the whole rendering processing unit 603 performs whole rendering of the original data D1 in conformity with the calculated printing area image size P1.

Next, the whole rendering processing unit 603 stores, in a memory, post-whole rendering image data D5, which has been obtained by performing rendering in whole.

The partial rendering processing unit 604 is a processing unit which performs rendering in part with respect to the original post-replacement data E1 based on the extraction result information E3, which is coincident with field information of the acquired variable replacement data D3, and the print setting data D2.

First, the partial rendering processing unit 604 acquires, from the partial rendering determination unit 602, the original post-replacement data E1 subjected to replacement by the variable data replacement unit 601 and the extraction result information E3.

Next, the partial rendering processing unit 604 acquires the print setting data D2 acquired by the print setting data acquisition unit 503.

Next, the partial rendering processing unit 604 calculates the printing area image size P1 from the original post-replacement data E1 and the print setting data D2.

Next, the partial rendering processing unit 604 performs rendering processing in part with respect to the original post-replacement data E1 based on the calculated printing area image size P1 and the acquired extraction result information E3.

Next, the partial rendering processing unit 604 sets data converted into an image by performing rendering processing in part as the post-partial rendering image data D6 and transmits the post-partial rendering image data D6 to the rendering image composition unit 605. Moreover, the partial rendering processing unit 604 transmits, to the rendering image composition unit 605, coordinate data E4, which indicates a region converted into an image by performing rendering processing in part with respect to the calculated printing area image size P1.

The rendering image composition unit 605 is a processing unit which performs image composition for combining image data which has preliminarily been rendered in whole with image data which has been rendered in part.

First, the rendering image composition unit 605 acquires the post-partial rendering image data D6, which has been obtained by performing rendering processing in part, from the partial rendering processing unit 604. Moreover, the rendering image composition unit 605 acquires the coordinate data E4, which indicates a region converted into an image by performing rendering processing in part, with respect to the calculated printing area image size P1.

Next, the rendering image composition unit 605 acquires the post-whole rendering image data D5, which has been stored by the whole rendering processing unit 603.

Next, the rendering image composition unit 605 performs image composition to combine the acquired post-whole rendering image data D5 with the post-partial rendering image data D6 based on the coordinate data E4, and thus generates the printing post-image composition data D7.

For example, the rendering image composition unit 605 temporarily stores, in the RAM 103, the post-whole rendering image data D5, which has been obtained by whole rendering with record 1 of the replacement data. Then, the rendering image composition unit 605 performs image composition by replacing the post-partial rendering image data D6 acquired from the partial rendering processing unit 604 on the position of the coordinate data E4 of the post-whole rendering image data D5 temporarily stored in the RAM 103.

Next, the rendering image composition unit 605 transmits, as the printing image data D4, the printing post-image composition data D7 obtained by image composition to the output image creation unit 506.

### 3-2 Flowchart in Second Embodiment

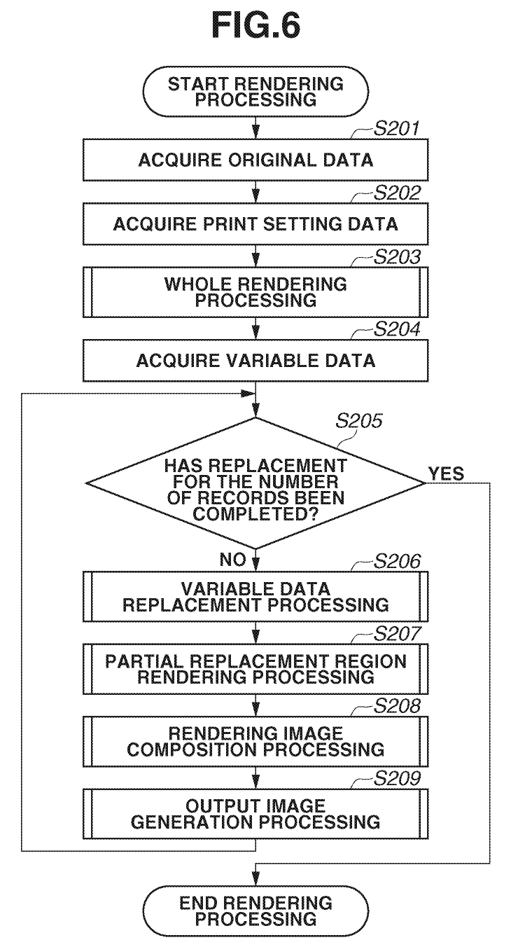

FIG. 6 is a flowchart used to explain rendering processing in variable printing, which is characteristic in the second embodiment.

Referring to the flowchart of FIG. 6, the rendering processing unit 505 performs processing for preliminarily performing whole rendering with respect to original data D1 obtained before replacement of variable data. Then, the rendering processing unit 505 performs processing for performing partial rendering with respect to the original post-replacement data E1 obtained by replacement and performing image composition to combine the obtained post-partial rendering image data D6 with the post-whole rendering image data D5, which has been obtained by preliminarily performing whole rendering.

First, in step S201, the above-mentioned original data acquisition unit 502 illustrated in FIG. 4 performs processing for acquiring original data D1.

Step S201 is similar to step S101 in the first embodiment and is, therefore, omitted from description.

Next, in step S202, the above-mentioned print setting data acquisition unit 503 illustrated in FIG. 4 performs print setting data acquisition processing for acquiring, as print setting data D2, model information about a printer and print setting information which are used for performing printing.

Step S202 is similar to step S102 in the first embodiment and is, therefore, omitted from description.

Next, in step S203, the above-mentioned whole rendering processing unit 603 illustrated in FIG. 4 performs rendering in whole with respect to the acquired original data D1 based on the acquired print setting data D2.

Specifically, in step S203, the whole rendering processing unit 603 performs the above-mentioned whole rendering processing in the second embodiment.

Next, in step S204, the above-mentioned variable replacement data acquisition unit 504 illustrated in FIG. 4 performs variable data acquisition processing for acquiring variable replacement data D3 to perform variable printing.

Step S204 is similar to step S103 in the first embodiment and is, therefore, omitted from description.

Next, in step S205, the rendering processing unit 505, while performing replacement processing a number of times corresponding to the number of records of information obtained after replacement of the variable replacement data D3 acquired in step S204, determines whether replacement processing for the number of times corresponding to the number of records has been completed.

If, in step S205, it is determined that replacement processing for the number of times corresponding to the number of records of information obtained after replacement of the variable replacement data D3 has been completed (YES in step S205), the rendering processing unit 505 determines that rendering processing has ended. If it is determined that replacement processing for the number of times corresponding to the number of records of information obtained after replacement of the variable replacement data D3 has not been completed (NO in step S205), the rendering processing unit 505 advances the processing to variable data replacement processing step S206 described below.

Next, in step S206, the above-mentioned variable data replacement unit 601 illustrated in FIG. 4 performs processing for replacement using the variable replacement data D3 with respect to the original data D1.

Specifically, in step S206, the variable data replacement unit 601 performs the above-mentioned replacement processing.

Next, in step S207, the above-mentioned partial rendering processing unit 604 illustrated in FIG. 4 performs rendering in part with respect to the original post-replacement data E1 based on the extraction result information E3 coincident with field information of the acquired variable replacement data D3 and the print setting data D2.

Specifically, in step S207, the partial rendering processing unit 604 performs the above-mentioned partial rendering processing. After performing the partial rendering processing, the partial rendering processing unit 604 advances the processing to rendering image composition processing step S208 described below.

Next, in step S208, the above-mentioned rendering image composition unit 605 illustrated in FIG. 4 performs processing for performing image composition to combine image data obtained by preliminarily performing rendering in whole with image data obtained by performing rendering in part.

Specifically, in step S208, the rendering image composition unit 605 performs the above-described processing. The rendering image composition unit 605 transmits the printing post-image composition data D7, which has been converted into an image by the rendering image composition processing, to the output image creation unit 506, and then advances the processing to output image generation processing step S209 described below.

Next, in step S209, the above-mentioned output image creation unit 506 illustrated in FIG. 4 performs processing for creating an image file of the printing post-image composition data D7, which has been generated and converted into an image by the rendering processing unit 505.

After, in step S209, converting each image obtained by rendering into an image file, the output image creation unit 506 returns the processing to step S205 for determining whether replacement for the number of times corresponding to the number of records has been completed. As mentioned above, in a case where there is a plurality of pieces of record information as replacement information, the server computer 3000 repeats step S205 to step S209, thus repeating replacement processing and rendering processing. Moreover, data converted into an image file is transmitted to the data transmission processing unit 507 and is then transmitted to the subsequent printer driver or printer to be used for printing.

### 3-3 Effect of Second Embodiment

The above-described first embodiment is an embodiment which performs rendering in whole at the time of the first rendering after the variable replacement data D3 is received.

In the second embodiment, since whole rendering is performed before the variable replacement data D3 is received, partial rendering processing only needs to be performed after the variable replacement data D3 is received. For example, the user preliminarily selects original data D1 as a template original which the user wants to print and, after doing so, selects the variable replacement data D3. Assuming that the user selects the variable replacement data D3, it is supposed that it takes some time for the user to select a template and then select the variable replacement data D3. In the second embodiment, since it is possible to start whole rendering at a point of time of the original data D1 being selected, it becomes possible to make a processing time required for rendering processing shorter than in the first embodiment. Particularly, in the case of a configuration in which the user selects original data D1 on a browser and the server computer 3000 performs rendering thereon, the server computer 3000 is able to detect such a selection at the point of time when the user has selected original data D1 being vector data on the browser. Since the server computer 3000 is able to preliminarily start whole rendering in advance with respect to the selected original data D1 at the point of time of having detected such a selection, it becomes possible to shorten a processing time.

As described above, according to the first and second embodiments, in the case of performing rendering processing with respect to a plurality of pieces of original post-replacement data E1 illustrated in FIGS. 7B to 7D obtained by replacement in variable printing, it is possible to efficiently improve a whole processing time required for rendering processing.

The above-described first and second embodiments have been described with use of a functional configuration example of software of the image processing apparatus illustrated in FIG. 3. While FIG. 3 illustrates a functional configuration example of software of the server computer 3000, which mainly performs rendering processing for generating printing image data, the image processing apparatus is not limited to a server.

Without the use of the server computer 3000 illustrated in FIG. 2, software which runs on only the client computer 1000 can be employed. For example, each processing operation of rendering processing is included in a functional configuration of software of the client computer 1000.

Then, software which runs on the client computer 1000 can be used to select original data D1 to be received by the original data acquisition unit 502 illustrated in FIG. 4. Moreover, the client computer 1000 can be used to acquire print setting data D2 to be acquired by the print setting data acquisition unit 503 illustrated in FIG. 4 and to acquire variable replacement data D3 to be acquired by the variable replacement data acquisition unit 504 illustrated in FIG. 4.

If software which runs on the client computer 1000 is able to perform partial rendering determination processing, whole rendering processing, and partial rendering processing as with the first and second embodiments, the image processing apparatus is not limited to the server computer 3000. The client computer 1000 can be configured to include the constituent elements illustrated in FIG. 3. In that case, the client computer 1000 serves as an example of an image processing apparatus.

For example, referring to FIG. 2, as native applications, all of the pieces of source code are stored in the ROM 102 of the client computer 1000. Original data D1 is stored in the external storage device 104. The display device 110 of the display 1100 displays a screen for the native applications and displays a user interface which enables the user to select original data D1. The user uses, for example, a mouse or a keyboard of the input device 107 to select original data D1 from among a plurality of pieces of original data D1 displayed on the display device 110. The input device control unit 106 temporarily stores, in the RAM 103, the original data D1 selected by the user via the user interface displayed on the display device 110. The CPU 101 is used to perform conversion and preview displaying in such a way as to enable the temporarily stored original data D1 to be displayed on the display device 110.

Moreover, the display device 110 displays a user interface which enables the user to select print setting data D2. The input device control unit 106 is used for the user to perform print settings such as selection of a printer and setting of paper size via the user interface displayed on the display device 110. Moreover, the display device 110 provides a user interface which enables the user to input variable replacement data D3. The user selects variable replacement data D3 stored in the external storage device 104 via the user interface displayed on the display device 110.

In either case, the rendering processing unit 505, which is running on the server computer 3000, can be configured to be implemented on the client computer 1000.

Moreover, while native applications are used, hybrid applications can also be used. A hybrid application has a software configuration composed of a combination of a web application portion and a native application portion. The web application portion is created with a development language which is usable by any operating system (OS), including Windows OS and macOS, and is usable by any OS. Moreover, the native application portion has source code prepared for each OS, including Windows OS and macOS, and is created and usable by each OS. For example, a combination of applications is used in such a manner that a user interface portion which the user operates is a web application portion such as HTML, CSS, or JavaScript and a print processing portion is a native application portion such as C programming language or C++ language, which is specialized for each OS. In the case of using a software configuration composed of hybrid applications, even if a configuration in which the server computer 3000 is not used is employed, any method can be employed as long as it is a method capable of implementing a rendering processing unit.

While, in the above-described embodiments, it is assumed that original data D1 is selected via the client computer 1000, the above-described embodiments are not limited to this. For example, the mobile terminal 2000 can be used to select original data D1. The mobile terminal 2000 can perform, for example, an editing operation for a poster with respect to the original data D1 and connect to the server computer 3000 via a communication interface (I/F), and further can transmit the original data D1 to the client computer 1000 via the communication I/F. Alternatively, the mobile terminal 2000 can be configured to have the function capable of issuing an instruction for print settings to a printer driver and can implement the above-described embodiments only by the mobile terminal 2000.

In the above-described embodiments, in a case where rendering has never been performed with respect to original post-replacement data E1, the partial rendering determination unit 602 determines to perform rendering in whole. While the case where rendering has never been performed is set as a case where whole rendering is performed with respect to the first record of the variable replacement data D3, the above-described embodiments are not limited to this.

For example, there is a case where, when the number of characters to be replaced in the variable replacement data D3 is larger than the number of original characters obtained before replacement, the characters are arranged beyond a replacement region. In this case, as the number of characters to be replaced is larger, the size of a replacement region becomes larger. The region size obtained by replacement is subjected to partial rendering and is then combined with an image subjected to whole rendering for the purpose of performing rendering image composition. Conversely, as the number of characters to be replaced is smaller, it is possible to make the size of a replacement region smaller. However, if the region size obtained by replacement is subjected to partial rendering and is then combined with an image subjected to whole rendering for the purpose of performing rendering image composition in a similar manner, the following problem may arise. In a case where the region size obtained by replacement is smaller than the region size obtained before replacement, if the region obtained after replacement is intended to be combined with the region obtained before replacement, part of the text obtained before replacement may remain.

A method for solving such a problem can include selecting text the region size of which becomes the smallest at the time of replacement of the text from among text data obtained before replacement and the variable replacement data D3. Then, the method can include performing whole rendering with respect to the selected text and setting the text subjected to whole rendering as source data for performing rendering image composition, so that, since, even if partial rendering is performed for replacement for the second and subsequent rounds, the region size obtained after replacement exceeds the source region size, no problem arises.

Moreover, alternatively, the following method is conceivable. The whole rendering processing unit 603 deletes data obtained before replacement (e.g., text data) with respect to the original data D1 and then performs rendering in whole with respect to the original data D1 subjected to deletion. However, in either case, since, in a case where there is a portion which is not replaced, source data has to be employed, the above-mentioned methods are only applicable to a case where some replacement has occurred in all of the regions.

Although it will be limited, whether replacement in the variable replacement data D3 occurs with respect to all of the target replacement regions can be determined, and the above-mentioned methods can be applied to a case where replacement occurs with respect to all of the target replacement regions. Moreover, since there is also a case where there is a plurality of replacement regions in the original data D1, text the region size of which becomes the smallest at the time of replacement of the text can be determined, and whole rendering can be performed with the determined text being replaced. Thus, the whole rendering processing unit 603 replaces data obtained before replacement included in the original data D1 with data obtained after replacement the region size of which is the smallest of a plurality of pieces of data obtained after replacement and then performs rendering in whole. In this way, any method can be used as long as it is a method capable of performing whole rendering and partial rendering in a state in which, after replacement, no data obtained before replacement remains.

In the above-described embodiments, in a case where rendering has never been performed with respect to the original post-replacement data E1, the partial rendering determination unit 602 determines to perform rendering in whole. While, with regard to subsequent rendering, the partial rendering determination unit 602 determines to perform rendering in part for the purpose of performing rendering image composition, the above-described embodiments are not limited to this.

For example, there is a case where, for example, image data or SVG data which is originally large in data size overlaps a region to be subjected to replacement in the original data D1 and the background of text is transparent data. Alternatively, there is, for example, a case where the size of large data overlaps the front of a text region to be subjected to replacement. There is a case where, even if a region to be subjected to replacement is rendered in whole or is rendered in part, a rendering processing time does not vary. In this case, since the case where partial rendering is performed requires the addition of rendering image composition and is thus time-consuming, processing may become slow. Therefore, in this case, without partial rendering being just performed, performing whole rendering can be determined for rendering processing.

Each of the above-described embodiments is an example of a configuration, and another configuration which is capable of obtaining a similar beneficial effect using a similar method or different parameters can also be employed. Moreover, each of the above-described embodiments can also be applied to a system composed of a plurality of pieces of equipment (for example, a host computer, interface equipment, a reader, and a printer) and to an apparatus composed of one piece of equipment (for example, a printer, a copying machine, or a facsimile apparatus).

Additionally, aspects of each of the above-described embodiments can be attained by the following configuration. First, program code read out from a storage medium is written in a memory included in a function extension card inserted into a computer or a function extension unit connected to a computer. After that, for example, a CPU included in the function extension card or the function extension unit performs part of or the whole of actual processing, and the functions of each of the above-described embodiments are implemented by such processing. This case is also included in the present disclosure.

Furthermore, the above-described embodiments are only the ones which illustrate specific examples in implementing the present disclosure, and the technical scope of the present disclosure should not be construed to be limited by such specific examples. Thus, the present disclosure can be embodied in various forms without departing from the technical idea thereof or principal features thereof.

According to aspects of the present disclosure, it is possible to efficiently perform rendering with respect to original data in which pre-replacement data has been replaced with post-replacement data.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-011680 filed January 27, 2025, which is hereby incorporated by reference herein in its entirety.

What is claimed is:

1. An image processing apparatus comprising:
one or more processors; and
one or more memories storing instructions that, when executed by the one or more processors, cause the image processing apparatus to:
perform whole rendering processing for performing rendering in whole with respect to first original data based on print setting data;
replace pre-replacement data included in second original data with first post-replacement data;
perform partial rendering processing for performing rendering with respect to the first post-replacement data based on the print setting data; and
perform image composition for combining image data obtained as a result of rendering performed by the whole rendering processing and image data obtained as a result of rendering performed by the partial rendering processing,
wherein a region other than the pre-replacement data included in the second original data is identical to that included in the first original data.

2. The image processing apparatus according to claim 1, wherein the instructions further cause the image processing apparatus to generate the first original data by replacing the pre-replacement data included in the second original data with second post-replacement data.

3. The image processing apparatus according to claim 1, wherein the instructions further cause the image processing apparatus to create an image file of the image data obtained as a result of rendering performed by the whole rendering processing and create an image file of an image obtained by the image composition.

4. The image processing apparatus according to claim 1, wherein the instructions further cause the image processing apparatus to:
determine whether a predetermined condition is satisfied after the pre-replacement data has been replaced with the first post-replacement data;
if it is determined that the predetermined condition is satisfied, perform rendering with respect to the first post-replacement data based on the print setting data and perform image composition for combining image data obtained as a result of rendering performed with respect to the first original data by the whole rendering processing and image data obtained as a result of rendering performed by the partial rendering processing; and
if it is determined that the predetermined condition is not satisfied, perform rendering in whole with respect to the first original data in which the pre-replacement data has been replaced with the first post-replacement data.

5. The image processing apparatus according to claim 4,
wherein the predetermined condition is a condition in which a first processing time is shorter than a second processing time,
wherein the first processing time is a total time of a processing time required for performing rendering with respect to the first post-replacement data based on the print setting data and a processing time required for performing image composition for combining image data obtained as a result of rendering performed with respect to the first original data by the whole rendering processing and image data obtained as a result of rendering performed by the partial rendering processing, and
wherein the second processing time is a processing time required for performing rendering in whole with respect to the first original data in which the pre-replacement data has been replaced with the first post-replacement data.

6. The image processing apparatus according to claim 4, wherein the predetermined condition is a condition in which predetermined data is included in a region other than the pre-replacement data included in the second original data.

7. The image processing apparatus according to claim 6, wherein the predetermined data is image data with a size greater than or equal to a first threshold value, Scalable Vector Graphics (SVG) data with a size greater than or equal to a second threshold value, or font data with a size greater than or equal to a third threshold value.

8. The image processing apparatus according to claim 1, wherein each of the pre-replacement data and the first post-replacement data is text data.

9. The image processing apparatus according to claim 8, wherein a region other than the pre-replacement data included in the second original data includes image data, Vector Graphics (SVG) data, or font data.

10. The image processing apparatus according to claim 2, wherein the second post-replacement data is the smallest in region size of a plurality of pieces of post-replacement data.

11. The image processing apparatus according to claim 1, wherein the second original data is identical to the first original data.

12. The image processing apparatus according to claim 1, wherein the first original data is data obtained by deleting the pre-replacement data with respect to the second original data.

13. The image processing apparatus according to claim 11, wherein the instructions further cause the image processing apparatus to, without creating an image file of image data obtained as a result of rendering performed by the whole rendering processing, create an image file of an image obtained by the image composition.

14. A processing method for an image processing apparatus, the method comprising:
performing whole rendering processing for performing rendering in whole with respect to first original data based on print setting data;
replacing pre-replacement data included in second original data with first post-replacement data;
performing partial rendering processing for performing rendering with respect to the first post-replacement data based on the print setting data; and
performing image composition for combining image data obtained as a result of rendering performed by the whole rendering processing and image data obtained as a result of rendering performed by the partial rendering processing,
wherein a region other than the pre-replacement data included in the second original data is identical to that included in the first original data.

15. A non-transitory computer-readable storage medium storing computer-executable instructions that, when executed by a computer, cause the computer to perform a processing method for an image processing apparatus, the method comprising:
performing whole rendering processing for performing rendering in whole with respect to first original data based on print setting data;
replacing pre-replacement data included in second original data with first post-replacement data;
performing partial rendering processing for performing rendering with respect to the first post-replacement data based on the print setting data; and
performing image composition for combining image data obtained as a result of rendering performed by the whole rendering processing and image data obtained as a result of rendering performed by the partial rendering processing,
wherein a region other than the pre-replacement data included in the second original data is identical to that included in the first original data.
